(19) United States
(12) Patent Application Publication
(10) Pub. No.: US 2011/0286139 A1
(43) Pub. Date: Nov. 24, 2011

(54) NON-SOLID CONDUCTIVE SURGE ABSORBER

(76) Inventor: Tsan-Chi CHEN, Chung Ho City (TW)

(21) Appl. No.: 12/782,792

(22) Filed: May 19, 2010

(51) Int. Cl. H02H 1/00

(52) U.S. Cl. 361/121

(57) ABSTRACT

The present invention is to provide a non-solid conductive surge absorber, which comprises a non-solid conductor formed by evenly mixing a non-solid solvent and a conductive medium and filled in a shielding case thereof in a watertight manner, and a plurality of metal plates each mounted on the shielding case in a watertight manner with a first end inside the shielding case and a second end extended out of the shielding case. Therefore, when a surge is generated, the number of electric charges accumulated on the metal plate connected to a circuit due to the surge will cause the conductive medium evenly dispersed in the non-solid solvent to rapidly and electrically connect with each other, so that the electric charges can be discharged to a ground terminal through the non-solid conductor for efficiently preventing electronic components on the circuit from being damaged by the surge.

### FIELD OF THE INVENTION

The present invention relates to a surge absorber, more particularly to a non-solid conductive surge absorber having a non-solid conductor filled therein in a watertight manner, wherein the non-solid conductor is formed by evenly mixing a non-solid solvent and a conductive medium for enabling the conductive medium evenly dispersed in the non-solid solvent to rapidly and electrically connect with each other when a surge is generated and then discharging electric charges accumulated on a metal plate to a ground terminal, so as to efficiently prevent electronic components on a circuit connected to the metal plate from being damaged by the surge.

### BACKGROUND OF THE INVENTION

Recently, with the development of electronic technologies, various electronic devices, such as computers, telephones, televisions, refrigerators, air conditioners, printers and faxes, have become essential tools in daily work and life of humans. To increase the operation life of the electronic devices and prevent malfunctions during the operation thereof, all related manufacturers have tried to develop malfunction-prevention and circuit-protection technologies. Among various factors causing malfunctions of the electronic devices, the surge (transient voltage overload) is the most common factor, which causes the most serious impact to various electronic devices. When the surge occurs, the surge will interfere electronic components in the electronic devices, and even cause the irreparable damage of the electronic components, so that the electronic devices will not normally operate.

According to the research and analysis, common surges include the following two types:

(1) Lightning surge: the lightning surge is generated by lightning. When the lightning hits a power line adjacent to an electronic device, a certain current enters a building through the power line, and then enters the electronic device through power distribution lines in the building and a power cable of the electronic device, so as to generate a lightning surge in circuits of the electronic device to impact electronic components in the circuits.

(2) Switching surge: the switching surge is generated by switching on/off a circuit. When a switch component is converted from an open circuit state to a closed circuit state (or from a close circuit state to an open circuit state), the transient conversion of the circuit causes a substantial voltage variation in the circuit within a very short time, so that electronic components of the circuit load transient overload voltage.

Each of the lightning surge and the switching surge impacts the electronic device in different degree, such as slightly damaging the electronic device, or seriously causing a short circuit of the electronic device and fire. To avoid the foregoing problems, the manufacturer generally installs a surge absorber in the circuit of the electronic device, in order to prevent the electronic components in the electronic device from being damaged by a transient overload voltage.

A traditional surge absorber includes a varistor (also known as a voltage dependent resistor or VDR), wherein the most common varistor is the metal oxide varistor (MOV) which comprises a ceramic piece made of zinc oxide particles and a small amount of other metal oxides spaced apart from each other. The ceramic piece is sandwiched between two metal plates, wherein a boundary area of the zinc oxide particles and the adjacent metal oxides generates a diode effect. Because a large number of particles are distributed in the varistor, the varistor is equivalent to the large number of diodes connected to each other. In a low voltage condition, the diodes in the varistor only have very small reverse leakage current. However, in a high voltage condition, the diodes generate reverse breakdown due to the hot electron effect and the tunnel effect, so that a large current can pass therethrough. Thus, the current-voltage property curve of the varistor is highly nonlinear, i.e. low resistance and large current in a high voltage state; high resistance and small current in a low voltage state, as shown in FIG. 1.

Referring now to FIGS. 2A and 2B, a circuit is used to describe the operational principle of the varistor applied to the surge absorber. As shown in FIG. 2A, the circuit comprises a power source V, an electronic component R and a varistor VDR. When the power source V keeps a normal operational voltage, the varistor VDR is in a standby mode. At this time, because the resistance value of the varistor VDR is very high (up to several megaohms) and apparently higher than that of the electronic component R, the current I₁ generated by the power source V can hardly pass through the varistor VDR, and only can pass through the electronic component R. Thus, the electronic component R can normally work. However, as shown in FIG. 2B, when a surge is generated in the circuit, the resistance value of the varistor VDR is transiently lowered down (down to only several ohms), so that a large current I₂ of the surge will pass through the varistor VDR, instead of the electronic component R. Thus, the surge absorber can prevent the surge from impacting other electronic components of the circuit, so as to efficiently avoid the damage of the electronic device and to enhance the operational safety of the electronic device.

However, the traditional surge absorber using the varistor only can bear limited energy or power, i.e. only can load the large voltage within a short time, but can not continuously provide over-voltage protection. According to the researches of the National Fire Protection Association (NFPA), when a short circuit of a circuit occurs, the over-voltage passing through the varistor easily causes the burn and combustion of the varistor, wherein many electrical fires are caused by the burn of the surge absorbers. Besides, there are other shortcomings existing in the traditional surge absorber, as follows: Except for the booting current impact which can not be prevented, when the surge absorber is impacted by an over-current generated by strong lightning, the surge absorber may possibly be broken by the over-current and can not further provide the surge absorbing effect. However, it is difficult for the user to detect whether the surge absorber has been broken from the appearance of the electronic device, so the user may continue to use the electronic device. Thus, when the next lightning or switching surge occurs, the electronic device can not bear the surge impact again, so that the electronic components in the electronic device will be damaged by the surge to even cause a fire danger.

In addition to the foregoing surge absorber using the varistor, there further is a type of surge absorber using a ceramic gas discharge tube. However, for this type of the surge absorber, a gas must be filled into a discharge tube, so that the manufacturing process thereof is relatively difficult, resulting in increased cost thereof. Moreover, the gas in the discharge tube is easily leaked, so as to affect the conductive performance of the discharge tube, and even loss the function thereof. Furthermore, when the surge absorber bears the surge, the gas in the discharge tube will be ionized and expanded due to the electric power. Thus, the discharge tube may be cracked, so that the gas tightness of the discharge tube will be affected and the surge absorber can not further absorb the surge again, resulting in losing the circuit protection function.

As a result, it is important for designers and manufacturers to think how to improve the foregoing problems of the traditional surge absorbers to use other alternative means for absorbing surges except for the varistor and the discharge tube, in order to efficiently improving the safety and operation life of surge absorbers.

It is therefore tried by the inventor to develop a non-solid conductive surge absorber to solve the problems existing in the traditional surge absorbers as described above, so as to efficiently improve the safety of the surge absorber and protect a circuit from being interfered by surges, for the purpose of enhancing the operation safety and life of an electronic device.

### BRIEF SUMMARY OF THE INVENTION

A primary object of the present invention is to provide a non-solid conductive surge absorber, which comprises a shielding case, a plurality of metal plates and a non-solid conductor, wherein the shielding case is formed with a receiving space therein, and a side surface of the shielding case is provided with a plurality of openings. Each of the metal plates is passed through each of the corresponding openings and mounted on each of the corresponding openings in a watertight manner. A first end of each of the metal plates is inserted into the receiving space, and a second end thereof is extended out of the shielding case to be electrically connected with a corresponding contact (such as a contact of a neutral line, a hot line or a ground line) of a circuit (or a printed circuit board). The non-solid conductor is filled into the receiving space in a watertight manner, and the non-solid conductor is formed by evenly mixing a non-solid solvent and a conductive medium (such as conductive carbon black or other metal particles), wherein the solvent is a non-conductive liquid, such as grease (e.g. triglyceride), mineral oil, etc. Therefore, when a surge is generated in the circuit due to lightning or other factors and the number of electric charges generated by the surge on one of the metal plates (connected to the hot line or the neutral line) is accumulated to a predetermined voltage level, the electric charges will cause that the conductive medium evenly dispersed in the non-solid conductor is rapidly and electrically connected with each other, so that the electric charges can be discharged to a ground terminal through one of the adjacent metal plates (connected to the ground line) for efficiently preventing electronic components on the circuit from being damaged by the surge.

A secondary object of the present invention is to provide a non-solid conductive surge absorber, wherein a part of each of the metal plates located within the receiving space has a side surface opposite to one of the adjacent metal plates and formed with at least one projection (i.e. tooth), so that the electric charges on the metal plates can be gathered on the projection. When a surge is generated on the circuit installed with the surge absorber, the surge will cause the electric charges to be accumulated on the projection. When the number of the accumulated electric charges causes the voltage level to be a predetermined value, the electric charges will cause that the conductive medium evenly dispersed in the non-solid conductor is rapidly and electrically connected with each other.

A third object of the present invention is to provide a non-solid conductive surge absorber, wherein the shielding case comprises an upper case and a lower case. The lower case has two opposite side formed with an engaging portion, respectively, while the upper case has two inner sides formed with an engaging hole corresponding to each of the engaging portions. In a case that the lower case is inserted into the upper case, each of the engaging portions can be engaged with each of the engaging holes. Thus, the manufacturer can rapidly install the shielding case to enhance the manufacture efficiency.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein

FIG. 1 is a diagram of voltage and current characteristics of a varistor;

FIG. 2A is a schematic view of the varistor in a standby mode;

FIG. 2B is a schematic view of the varistor in an operational mode;

FIG. 3 is an exploded perspective view of a non-solid conductive surge absorber according to a first preferred embodiment of the present invention;

FIG. 4 is an assembled cross-sectional view of the non-solid conductive surge absorber according to the first preferred embodiment of the present invention; and

FIG. 5 is an assembled cross-sectional view of a non-solid conductive surge absorber according to a second preferred embodiment of the present invention.

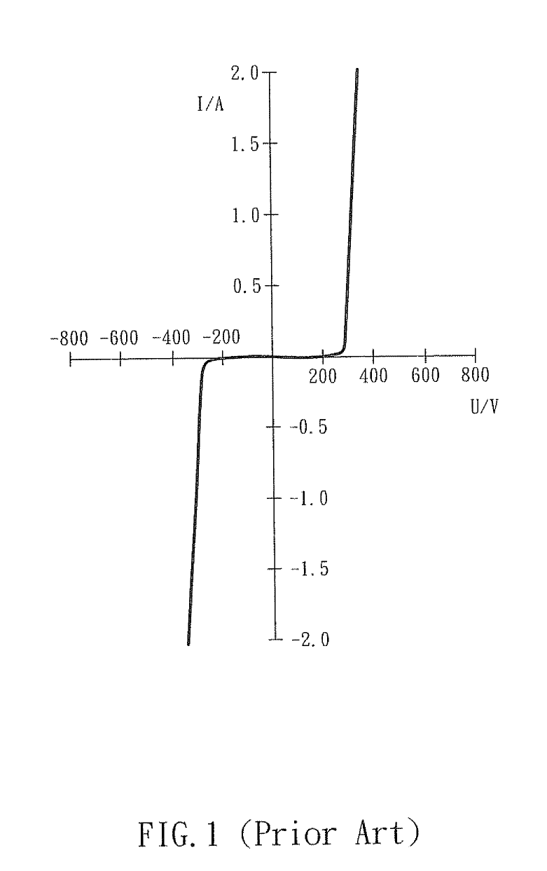

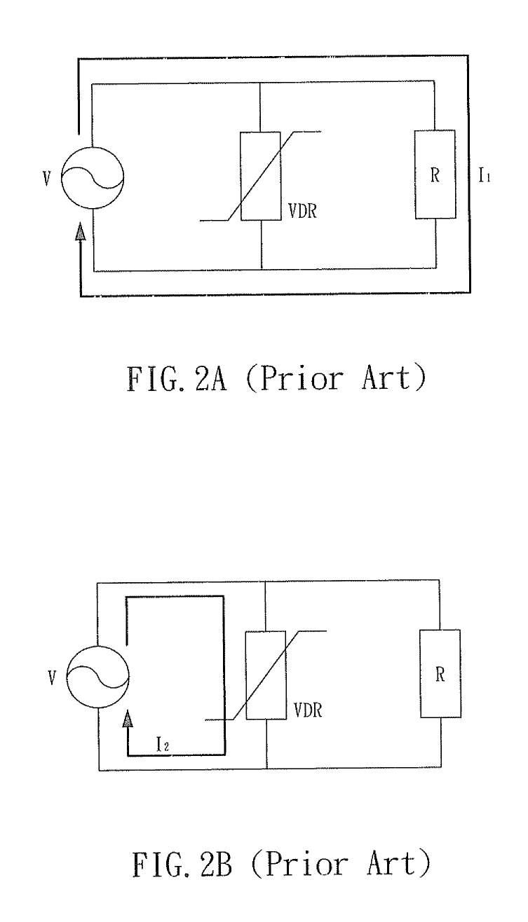

### DETAILED DESCRIPTION OF THE INVENTION

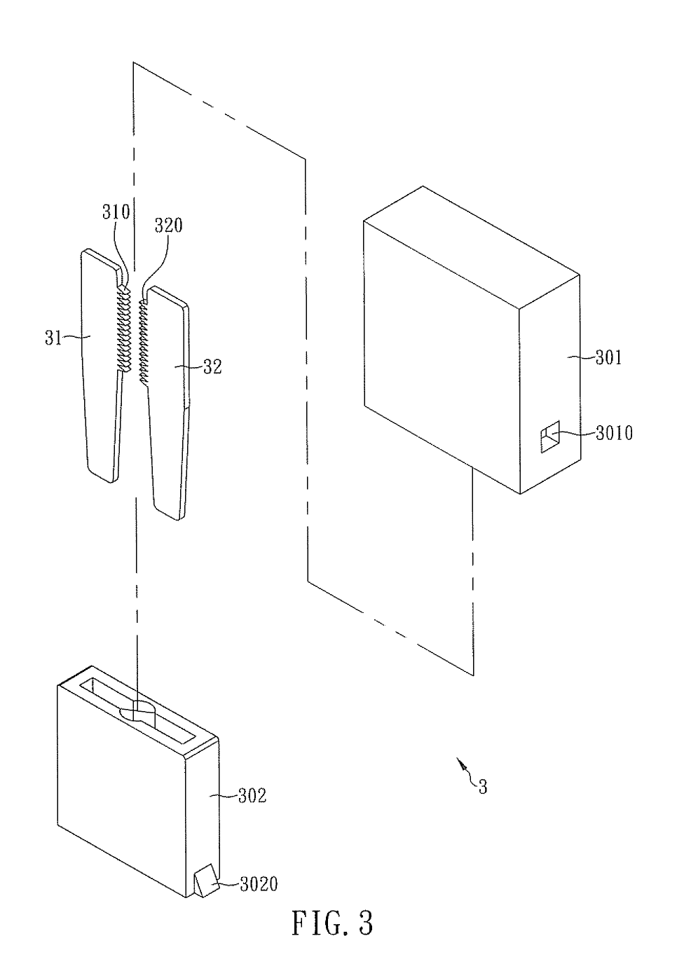

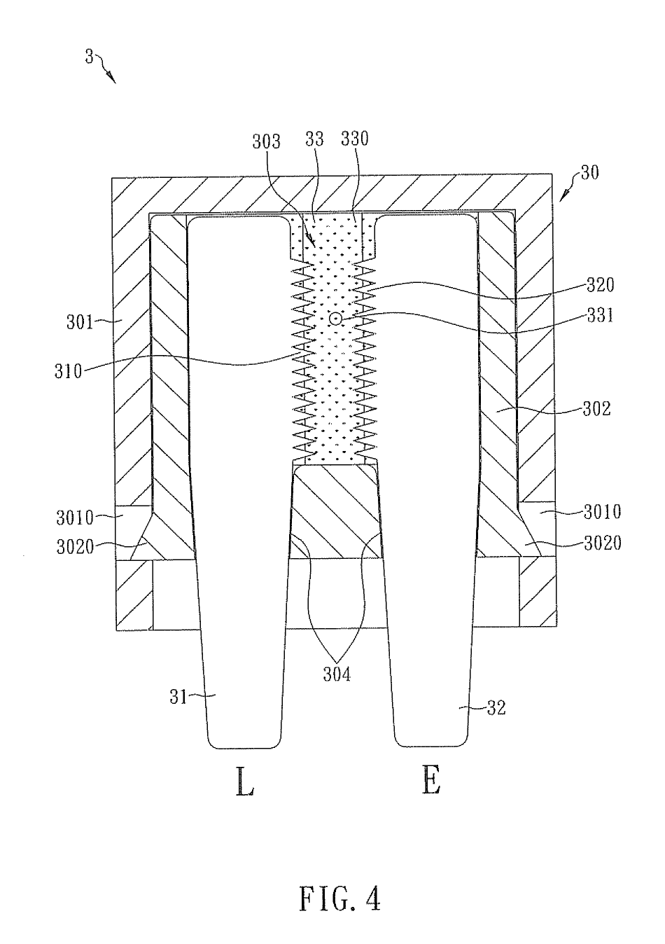

The present invention is a non-solid conductive surge absorber. Referring now to FIGS. 3 and 4, according to a first preferred embodiment of the present invention, a non-solid conductive surge absorber 3 comprises a shielding case 30, a plurality of metal plates 31, 32 and a non-solid conductor 33, wherein the shielding case 30 comprises an upper case 301 and a lower case 302. The lower case 302 has two opposite sides formed with an engaging portion 3020, respectively, while the upper case 301 has two inner sides formed with an engaging hole 3010 corresponding to each of the engaging portions 3020, respectively. In a case that the lower case 302 is inserted into the upper case 301, each of the engaging portions 3020 can be engaged with and put into each of the engaging holes 3010, respectively, so that the upper case 301 and the lower case 302 can be tightly connected with each other. Furthermore, the shielding case 30 is formed with a receiving space 303 therein, and a side surface of the shielding case 30 is provided with a plurality of openings 304, wherein each of the metal plates 31, 32 is passed through each of the corresponding openings 304 and mounted on each of the corresponding openings 304 in a watertight manner without leakage. To strengthen the watertight effect, the manufacturer can apply an adhesive to (the openings 304 on) a lower side of the shielding case 30. Moreover, a first end of each of the metal plates 31, 32 is inserted into the receiving space 303, and a second end thereof is extended out of the shielding case 30, so that one of the metal plates (first metal plate 31) can be electrically connected with a hot-line contact on a printed circuit board, while the other of the metal plates (i.e. the second metal plate 32) can be electrically connected with a ground-line contact on the printed circuit board. As shown in FIG. 4, the letter “L” means “Line”, and the letter “E” means “Earth” or “Ground”.

In addition, referring still to FIGS. 3 and 4, a part of one of the metal plates (i.e. the first metal plate 31) located within the receiving space 303 has a side surface opposite to the other of the adjacent metal plates (i.e. the second metal plate 32) and formed with a plurality of projections 310 (i.e. the teeth), while a part of the second metal plate 32 located within the receiving space 303 has a side surface opposite to the adjacent first metal plate 31 and formed with a plurality of projections 320 on the side surface. The projections 310, 320 are advantageously used to gather electric charges on the metal plates 31, 32 can be gathered on the projections 310, 320 by the skin effect, wherein the skin effect is a phenomenon that current (electric charges) are not evenly distributed in a conductor when the conductor has an alternative current or an alternating electromagnetic field therein. In a distribution trend of the current, when the distance apart from the surface of the conductor increases, the current density in the conductor decreases in an index relationship. In other words, most of the currents of the conductor are gathered on the surface thereof. If the conductor is observed from a cross-sectional direction vertical to a current direction, the current strength in a center of the conductor is basically zero, i.e. almost no current pass through the center, and the current is only gathered on edges of the conductor.

When a surge is generated in the circuit installed with the surge absorber, the surge will cause the electric charges to be accumulated on the projection. When the number of the accumulated electric charges causes the voltage level to be a predetermined value, the electric charges will rapidly cause that the conductive medium evenly dispersed in the non-solid conductor is electrically connected with each other.

In the first preferred embodiment of the present invention, referring back to FIG. 4, the non-solid conductor 33 is filled into the receiving space 303 in a watertight manner, and the non-solid conductor 33 is formed by evenly mixing a non-solid solvent 330 and a conductive medium 331. In the embodiment, the solvent 330 is preferably grease (e.g. triglyceride) which is a non-conductive liquid, while the conductive medium 331 is preferably conductive carbon black particles with an averaged particle diameter ranged from 30 to 40 nm. In a case that the weight ratio of the conductive medium 331 and the non-solid solvent 330 is 5%:95%, the inventor of the present invention detected and found that the non-solid conductor 33 has a surface resistance about 104 to 106 ohms (Ω). Besides, in the embodiment, the specific gravity of the conductive medium 331 (about 0.4 to 0.6) is smaller than that of the non-solid solvent 330 (about 0.8 to 0.93), wherein the specific gravity is a relative density that is a density ratio of a substance and purified water under the standard atmospheric pressure and 3.98° C. However, the present invention is not limited to the foregoing values, and the manufacturers can vary components, specific gravity and weight ratio of the non-solid solvent 330 and the conductive medium 331. When the conductive medium 331 and the non-solid solvent 330 are evenly mixed, the conductive medium 331 can overcome the influence of gravity by the Brownian motion, so as to be evenly dispersed and suspended in the non-solid solvent 330. Thus, the non-solid conductor 33 can provide an even and stable conductive property. The so-called “Brownian motion” means that small particles suspended in a liquid or the air can continuously and rapidly move in an irregular and random manner, wherein the motion is caused by mutual collision between the small particles or impacts from liquid or gaseous molecules.

In the first preferred embodiment of the present invention, referring to FIG. 4 again, when a circuit installed with the surge absorber 3 generates a surge due to lightning or other factors, the surge causes that electric charges are accumulated on the projections 310 of the first metal plate 31. If the number of the electric charges is accumulated to cause a voltage level to be a predetermined value, the electric charges will cause that the conductive medium 331 evenly dispersed in the non-solid conductor 33 is rapidly and electrically connected with each other, so that the electric charges can be discharged to a ground terminal through the adjacent second metal plate 32 (connected to the ground line) for efficiently preventing electronic components on the circuit from being damaged by the surge. The present invention uses the non-solid conductor 33 as discharge medium. Thus, even though the strength of the surge is relatively high, the non-solid conductor 33 can not be broken by the surge. As a result, the present invention can substantially increase the operational life of the surge absorber 3, and efficiently prevent the circuit damage problem of the traditional surge absorber, wherein the user can not tell whether the traditional surge absorber has been broken from the appearance of an electronic device and thus may continue to use the electronic device to cause the damage of the electronic device. Therefore, the present invention also can substantially increase the safety of the surge absorber 3. In addition, the surge absorber 3 of the present invention is used to replace a discharge tube, so that the crack or leakage problems of the discharge tube due to the gas expansion or leakage can be avoided. Thus, the surge absorber 3 of the present invention can provide the better surge absorbing effect than that of various traditional surge absorbers.

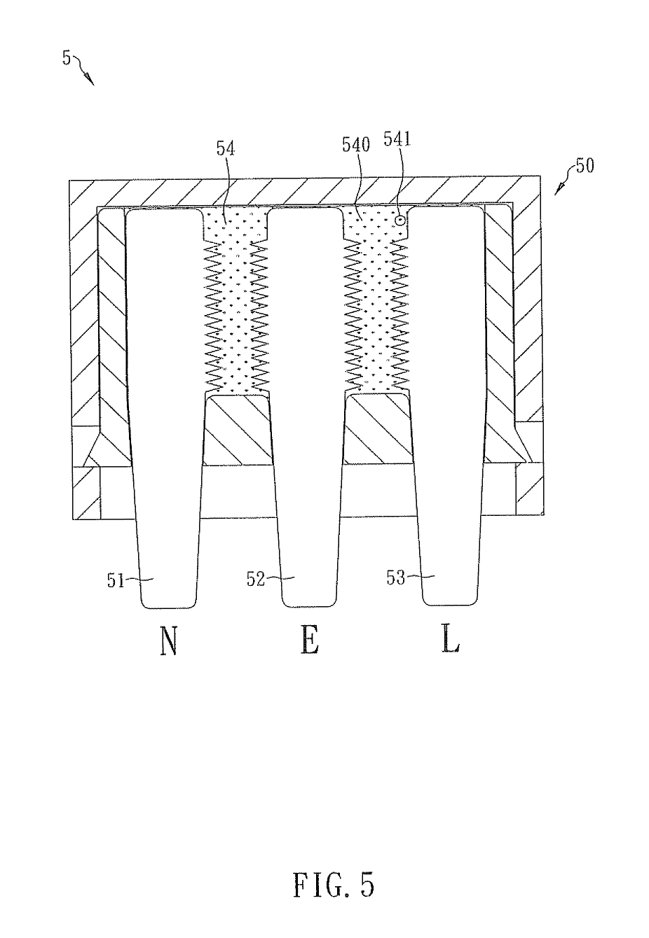

In a second preferred embodiment of the present invention, referring to FIG. 5, a non-solid conductive surge absorber 5 comprises a shielding case 50, three metal plates 51, 52, 53 and a non-solid conductor 54, wherein each of the metal plates 51, 52, 53 is connected to a neutral-line contact, a ground-line contact and a hot-line contact on a printed circuit board, respectively. As shown in FIG. 5, the letter “N” means “Neutral”, and the letter “E” means “Earth” or “Ground”, while the letter “L” means “Line”. Furthermore, the non-solid conductor 54 is formed by evenly mixing a non-solid solvent 540 and a conductive medium 541. In the embodiment, the solvent 540 is preferably mineral oil, which is a non-conductive liquid, while the conductive medium 541 is preferably lithium particles, wherein the specific gravity of the lithium particles is about 0.534 and the lithium particles are good conductors. It should be noted that the manufacturers can vary the foregoing preferred embodiments to replace the non-solid solvent 540 by other substance or to replace the conductive medium 541 by other metal particles. Only if the conductive medium 541 can be evenly suspended and dispersed in the non-solid solvent 540, the conductive medium 541 and the non-solid solvent 540 can be used to carry out the present invention. In the second preferred embodiment, when a surge is generated and electric charges are accumulated on the metal plate 51 or 53, a current thereon can be electrically distributed and connected to the metal plate 52 through the rapidly conduction of the conductive medium 541, so that the current can be discharged to a ground terminal from the metal plate 52 to efficiently prevent electrical components on the circuit from be damaged by the surge.

As described above, only two preferred embodiments of the present invention are disclosed. It should be noted that the weight ratio or the specific gravity of the conductive medium and the non-solid solvent or the average particle diameter of the conductive medium is not limited to the foregoing preferred embodiments. The manufacturers can vary the weight ratio or the specific gravity of the conductive medium and the non-solid solvent or the average particle diameter of the conductive medium according to different desires and conditions (such as resistance, voltage, etc.) when designing the surge absorber of the present invention based on different installation positions or different electric appliances.

The present invention has been described with the preferred embodiments thereof and it is understood that many changes and modifications to the described embodiments can be carried out without departing from the scope and the spirit of the invention that is intended to be limited only by the appended claims.

What is claimed is:

1. A non-solid conductive surge absorber, comprising:
a shielding case formed with a receiving space therein, and having a side surface provided with a plurality of openings;
a plurality of metal plates, each of which is passed through a corresponding said opening and mounted on the corresponding said opening in a watertight manner, wherein a first end of each of the metal plates is inserted into the receiving space, while a second end thereof is extended out of the shielding case; and
a non-solid conductor filled into the receiving space in a watertight manner, and formed by evenly mixing a non-solid solvent and a conductive medium, wherein the solvent is a non-conductive liquid and a the solvent is greater than the conductive medium in gravity.

2. The non-solid conductive surge absorber according to claim 1, wherein a part of one of the metal plates located within the receiving space has a side surface opposite to the other of the adjacent metal plates and formed with a plurality of projections on the side surface.

3. The non-solid conductive surge absorber according to claim 2, wherein the shielding case comprises an upper case and a lower case.

4. The non-solid conductive surge absorber according to claim 3, wherein the lower case has two opposite sides formed with an engaging portion, respectively, while the upper case has two inner sides formed with an engaging hole corresponding to each of the engaging portions, respectively, so that each of the engaging portions is allowed to be engaged with and put into each of a corresponding said engaging hole, respectively when the lower case is inserted into the upper case.
